(19) United States
(12) Patent Application Publication
(10) Pub. No.: US 2025/0392997 A1
(43) Pub. Date: Dec. 25, 2025

(54) SMART TRANSMIT POWER WITH REAL TIME ANTENNA EFFICIENCY

(71) Applicant: QUALCOMM Incorporated, San Diego, CA (US)

(72) Inventor: Akash KUMAR, Hyderabad (IN)

(21) Appl. No.: 18/749,282

(22) Filed: Jun. 20, 2024

(51) Int. Cl. H04W 52/36; H04W 52/28

(52) U.S. Cl. CPC H04W 52/367; H04W 52/283

(57) ABSTRACT

Methods, systems, and devices for wireless communications are described. A user equipment (UE) may select a first transmit power level associated with a first expected radiation power from antenna(s) of the UE. Selection of the first transmit power level is based at least in part on the first expected radiation power complying with a specific absorption rate (SAR) threshold. The UE may increase the first transmit power level to a second transmit power level associated with a second expected radiation power from the antenna(s) of the UE. The increase to the second transmit power level is based on application of an antenna efficiency metric associated with the antenna(s) of the UE to the second expected radiation power to determine a reduced expected radiation power. The UE may perform transmission(s) from the antenna(s) at the second transmit power level based on the reduced expected radiation power satisfying the SAR threshold.

### FIELD OF TECHNOLOGY

The present disclosure relates to wireless communications, including smart transmit power with real time antenna efficiency.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include selecting, for the UE, a first transmit power level that is associated with a first expected radiation power from one or more antennas of the UE, where selection of the first transmit power level is based on the first expected radiation power being in compliance with a specific absorption rate threshold, increasing the first transmit power level to a second transmit power level that is associated with a second expected radiation power from the one or more antennas of the UE, where the increase to the second transmit power level is based on application of an antenna efficiency metric associated with the one or more antennas of the UE to the second expected radiation power to determine a reduced expected radiation power, and performing one or more transmissions from the one or more antennas at the second transmit power level based on the reduced expected radiation power satisfying the specific absorption rate threshold.

A UE for wireless communications is described. The UE may include one or more memories storing processor executable code, and one or more memories storing processor-executable code. The UE may include one or more processors coupled with the one or more memories, wherein the one or more processors are individually or collectively configured to cause the UE to select, for the UE, a first transmit power level that is associated with a first expected radiation power from one or more antennas of the UE, where selection of the first transmit power level is based on the first expected radiation power being in compliance with a specific absorption rate threshold, increase the first transmit power level to a second transmit power level that is associated with a second expected radiation power from the one or more antennas of the UE, where the increase to the second transmit power level is based on application of an antenna efficiency metric associated with the one or more antennas of the UE to the second expected radiation power to determine a reduced expected radiation power, and perform one or more transmissions from the one or more antennas at the second transmit power level based on the reduced expected radiation power satisfying the specific absorption rate threshold.

Another UE for wireless communications is described. The UE may include means for selecting, for the UE, a first transmit power level that is associated with a first expected radiation power from one or more antennas of the UE, where selection of the first transmit power level is based on the first expected radiation power being in compliance with a specific absorption rate threshold, means for increasing the first transmit power level to a second transmit power level that is associated with a second expected radiation power from the one or more antennas of the UE, where the increase to the second transmit power level is based on application of an antenna efficiency metric associated with the one or more antennas of the UE to the second expected radiation power to determine a reduced expected radiation power, and means for performing one or more transmissions from the one or more antennas at the second transmit power level based on the reduced expected radiation power satisfying the specific absorption rate threshold.

A non-transitory computer-readable medium storing code for wireless communications is described. The code may include instructions executable by one or more processors to select, for the UE, a first transmit power level that is associated with a first expected radiation power from one or more antennas of the UE, where selection of the first transmit power level is based on the first expected radiation power being in compliance with a specific absorption rate threshold, increase the first transmit power level to a second transmit power level that is associated with a second expected radiation power from the one or more antennas of the UE, where the increase to the second transmit power level is based on application of an antenna efficiency metric associated with the one or more antennas of the UE to the second expected radiation power to determine a reduced expected radiation power, and perform one or more transmissions from the one or more antennas at the second transmit power level based on the reduced expected radiation power satisfying the specific absorption rate threshold.

In some examples of the method, user equipment (UEs), and non-transitory computer-readable medium described herein, the antenna efficiency metric may be based on a voltage standing wave ratio (VSWR) associated with the one or more antennas.

Some examples of the method, user equipment (UEs), and non-transitory computer-readable medium described herein may further include operations, features, means, or instructions for measuring the VSWR associated with the one or more antennas according to a periodic schedule.

Some examples of the method, user equipment (UEs), and non-transitory computer-readable medium described herein may further include operations, features, means, or instructions for measuring the VSWR associated with the one or more antennas based on a state-change associated with the UE.

In some examples of the method, user equipment (UEs), and non-transitory computer-readable medium described herein, measuring the VSWR may include operations, features, means, or instructions for measuring an incident wave being provided to the one or more antennas via a transmission line and a reflected wave that may be reflected onto the transmission line from the one or more antennas.

In some examples of the method, user equipment (UEs), and non-transitory computer-readable medium described herein, the VSWR may be based on at least one of an impedance mismatch or a reflection coefficient associated with the one or more antennas.

In some examples of the method, user equipment (UEs), and non-transitory computer-readable medium described herein, the antenna efficiency metric may be based on a state of the UE.

Some examples of the method, user equipment (UEs), and non-transitory computer-readable medium described herein may further include operations, features, means, or instructions for determining a change to the state of the UE and updating the antenna efficiency metric according to the change to the state of the UE, where the update to the antenna efficiency metric may be associated with an update to the second transmit power level.

In some examples of the method, user equipment (UEs), and non-transitory computer-readable medium described herein, the state of the UE may be based on at least one of one or more sensor inputs associated with the UE, or a grip-state of the UE, or a fold-state of the UE, or an orientation of the UE, or a combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports smart transmit power with real time antenna efficiency in accordance with one or more aspects of the present disclosure.

FIG. 2 shows an example of a wireless communications system that supports smart transmit power with real time antenna efficiency in accordance with one or more aspects of the present disclosure.

FIG. 3 shows an example of a transmit/receive chain that supports smart transmit power with real time antenna efficiency in accordance with one or more aspects of the present disclosure.

FIG. 4 shows an example of a capture scheme that supports smart transmit power with real time antenna efficiency in accordance with one or more aspects of the present disclosure.

FIGS. 5 and 6 show block diagrams of devices that support smart transmit power with real time antenna efficiency in accordance with one or more aspects of the present disclosure.

FIG. 7 shows a block diagram of a communications manager that supports smart transmit power with real time antenna efficiency in accordance with one or more aspects of the present disclosure.

FIG. 8 shows a diagram of a system including a device that supports smart transmit power with real time antenna efficiency in accordance with one or more aspects of the present disclosure.

FIGS. 9 through 11 show flowcharts illustrating methods that support smart transmit power with real time antenna efficiency in accordance with one or more aspects of the present disclosure.

### DETAILED DESCRIPTION

Safety requirements associated with wireless communications may include a specific absorption rate (SAR) established as a metric of power being absorbed into human tissue per-unit weight. The SAR quantify a safe limit of exposure due to the radio operation of handheld devices, such as user equipment (UE). Accordingly, UE generally establish a transmit power level that considers—and complies with—the SAR for the user's safety. UE are also equipped with different power classes that determines the different maximum transmit power at the UE's transmit antenna(s). However, application of the SAR generally results in the UE being unable to adopt its maximum transmit power level. This may result in decreased uplink performance of the UE due to the decreased uplink transmit power.

Aspects of the techniques described herein generally consider the antenna efficiency when selecting the uplink transmit power of the UE. That is, the antenna efficiency metric of the UE's antenna(s) is generally less than perfect in that at least some of the transmit power applied to the transmission line feeding the antenna is lost (e.g., due to a voltage standing wave ratio (VSWR) or a state change of the UE). In some aspects, this may include the UE selecting or otherwise identifying, for the UE, a first transmit power level that is associated with a first expected radiation power from one or more antennas of the UE. The selection of the first transmit power level may be based at least in part on the first expected radiation power complying with a SAR threshold. The UE may also increase the first transmit power level to a second transmit power level that is associated with a second expected radiation power from the one or more antennas of the UE. This increase to the second transmit power level may be based on application of the antenna efficiency metric associated with the one or more antennas of the UE to the second expected radiation power to determine a reduced expected radiation power. The UE may perform transmission(s) from the one or more antennas at the second transmit power level based at least in part on the reduced expected radiation power satisfying the SAR threshold.

Aspects of the disclosure are initially described in the context of wireless communications systems. Aspects of the disclosure are further illustrated by and described with reference to apparatus diagrams, system diagrams, and flowcharts that relate to smart transmit power with real time antenna efficiency.

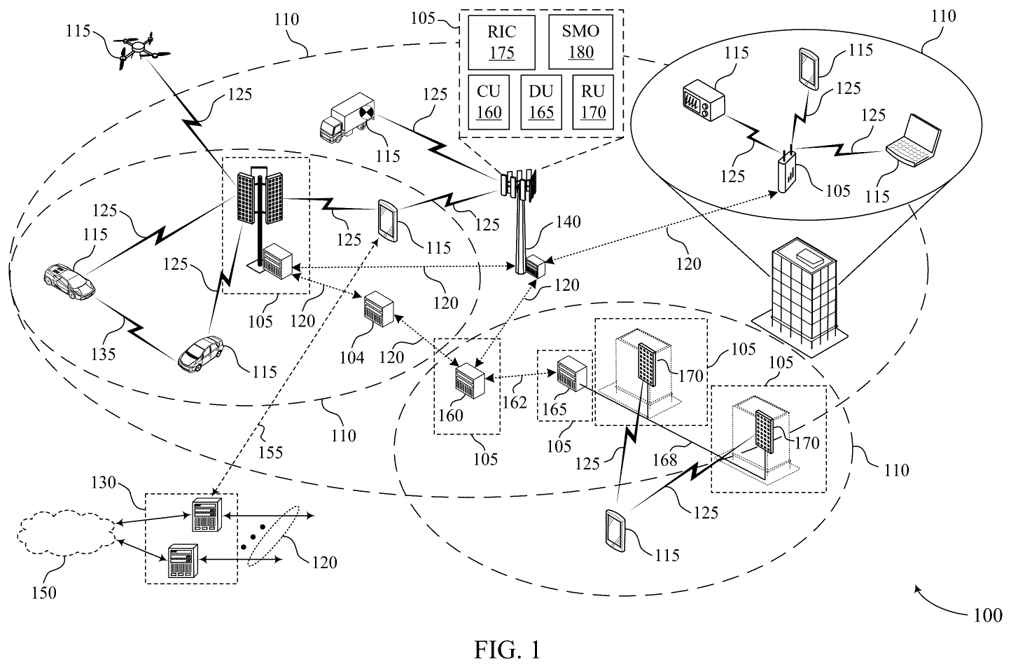

FIG. 1 shows an example of a wireless communications system 100 that supports smart transmit power with real time antenna efficiency in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may select, for the UE 115, a first transmit power level that is associated with a first expected radiation power from one or more antennas of the UE 115, wherein selection of the first transmit power level is based at least in part on the first expected radiation power being in compliance with a SAR threshold. The UE 115 may increase the first transmit power level to a second transmit power level that is associated with a second expected radiation power from the one or more antennas of the UE 115, wherein the increase to the second transmit power level is based at least in part on application of an antenna efficiency metric associated with the one or more antennas of the UE 115 to the second expected radiation power to determine a reduced expected radiation power. The UE 115 may perform one or more transmissions from the one or more antennas at the second transmit power level based at least in part on the reduced expected radiation power satisfying the SAR threshold.

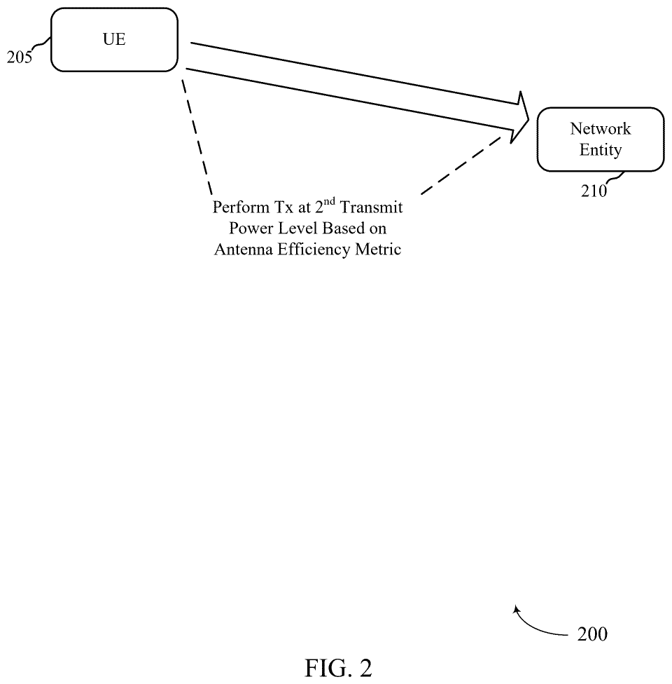

FIG. 2 shows an example of a wireless communications system 200 that supports smart transmit power with real time antenna efficiency in accordance with one or more aspects of the present disclosure. Wireless communications system 200 may implement aspects of wireless communications system 100. Wireless communications system 200 may include a UE 205 and a network entity 210, which may be examples of the corresponding devices described herein.

Wireless networks may utilize various power classes for UE, such as the UE 205. The power class (PC) may generally be used to identify or otherwise determine the maximum transmit power at the UE's transmit antenna(s). For example, some wireless networks may define a PC two (PC2) that permits the UE to perform wireless transmissions at the UE's transmit antenna(s) up to 26 dBm. Some wireless networks may define a PC three (PC3) that permits the UE to perform wireless transmissions at the UE's transmit antenna(s) up to 23 dBm. That is, each PC defines the signal level that is permitted to be transmitted as determined by the output at the transmit antenna(s) of the UE, with the output being radiated energy that is measured or otherwise determined in watt(s) (W) or dBm.

However, such wireless networks further impose a SAR (SAR) limitation on the UE's transmit power. The SAR is generally defined as a metric of the amount of power (e.g., radio frequency energy) that is absorbed by human tissue per unit weight. The SAR is generally used to quantify the safe limit of absorbed transmit power due to the radio operations of the handheld devices (e.g., the UE). Similar to the PC, the SAR is calculated relative to the transmit power at the UE's transmit antenna(s). That is, the SAR is a function of the total transmit power absorbed by human tissues as measured in power per unit mass (e.g., mW/kg). SAR generally assumes that in all smart transmit algorithms the transmit power that the user is exposed to is considered the same as the UE's attempted transmit power at the antenna(s). That is, the SAR is generally based on an assumption that the full transmit power of the UE is radiated from the transmit antenna(s) of the UE.

In some aspects, the SAR limitation generally results in a UE using a transmit power that is well below its PC. That is, in many practical scenarios, the UE's uplink transmit power needs to be limited below its advertised capability (e.g., the UE's PC) to meet the SAR limitation. This generally limits the UE's supported coverage area and uplink throughput. However, this approach may be unnecessary because the actual transmit power the UE is exposed to may depend on the antenna efficiency (e.g., active and passive) and the complete UE's transmit power at the antenna input may not be impacting human tissue. More particularly, a part of the transmit power may not be radiated out (and hence the user is not exposed to) but is, instead, reflected back from the transmit antenna(s) onto the transmission line feeding the antenna (e.g., from the power amplifier (PA) of the UE). That is, the amount of transmit power applied to or otherwise attempted to be coupled to the UE's transmit antenna(s) may not be radiated out from the antenna(s). Instead, at least some of the transmit power may be reflected back onto the transmission line from the antenna.

In some aspects, this may be due to an impedance mismatch at the antenna output based on, for example, external gripping, contact with a surface, and other factors. Due to reasons such as a smaller form factor, incorrect impedance matching at the antenna, and others, not all of the power delivered to the UE's transmit antenna(s) will be radiated out (e.g., and therefore the user will not be exposed to the total transmit power). Instead, some of this transmit power will be reflected back into the UE. Moreover, the antenna efficiency variation may also be a function of the UE's state, orientation, and the like. For example, the UE's antenna efficiency may vary 2-4 dB between a folded state and an unfolded state.

Accordingly, aspects of the techniques described herein provide various mechanisms for a UE to minimize its SAR backoff while maintaining compliance with the SAR threshold. For example, aspects of the described techniques provide for optimizing SAR compliance based on consideration of the real time antenna efficiency of the UE.

For example, the UE 205 may select or otherwise identify a first transmit power level that is associated with a first expected radiation power from antenna(s) of the UE 205. The UE 205 may select the first transmit power level based on the first expected radiation power complying with the SAR threshold. For example, the first transmit power level may be based on the amount of radio frequency energy that is expected to be radiated from the antenna(s) of the UE 205 at the first transmit power level. The first transmit power level may be based on an output power level from a PA or other component of the transmit chain of the UE 205 as applied to the antenna(s) (e.g., as coupled to the transmit antenna(s) of the UE via the transmission line). The first transmit power level may be selected in order to comply with the SAR threshold.

However, the UE 205 may increase the first transit power level to a second transmit power level that is associated with a second expected radiation power from the antenna(s) of the UE 205. The increase to the second transmit power level may be based on application of the antenna efficiency metric associated with the antenna(s) of the UE 205. Application of the antenna efficiency metric associated with the antenna(s) of the UE 205 to the second expected radiation power may result in or otherwise determine a reduced expected radiation power. That is, application of the antenna efficiency metric may account for the inefficiency or imperfection of the coupling of the transmit power applied to the transmission line and its coupling to the antenna(s) of the UE 205. The antenna efficiency metric may be based on an expected loss in the radio frequency energy from the antenna(s) of the UE 205 relative to the applied radiation power. The antenna efficiency metric may identify or otherwise be associated with the actual radiation power (e.g., the second expected radiation power, which is a reduced expected radiation power) from the antenna(s) being less than the expected radiation power (e.g., the first expected radiation power). The UE 205 may perform transmission(s) from the antenna(s) at the second transmit power level based on the reduced expected radiation power satisfying the SAR threshold.

Aspects of the techniques described herein may include the antenna efficiency metric of the transmit antenna(s) of the UE 205 being considered based on a voltage standing wave ratio (VSWR). The VSWR is generally based on the transmission line that couples the transmit power (e.g., from a PA output) to a load (e.g., such as the transmit antenna(s) of the UE 205). Both the transmission line and the antenna(s) have characteristic impedances or other reflection coefficient that, when not perfectly matched, results in at least some of the power from being coupled from the transmission line onto the antennas. In some aspects, connector(s) or other component(s) along the transmission line may have their impedance that introduces signal loss that may further be associated with a drop in transmit power level. Instead, some of the power is reflected back onto the transmission line, with the amount being reflected back being a function of the impedance mismatch (e.g., the antenna efficiency metric). The UE 205 may use the VSWR measurements to estimate or otherwise determine the reflected transmit power (and hence the real radiated transmit power) from the transmit antenna(s) of the UE 205. In some aspects, the UE 205 may measure or otherwise determine the VSWR according to a periodic schedule or based on a UE state-change based on any sensor input (e.g., such as a proximity sensor, whether the UE 205 is in a folded state or an unfolded state, and other inputs).

For example, the UE 205 may measure or otherwise determine an incident wave being provided to the antenna(s) via the transmission line and a reflected wave that is reflected onto the transmission line from the antenna(s) of the UE 205. The VSWR may be a function of the reflection coefficient, which describes the power reflected from the antenna(s) according to VSWR=1+|Γ|/1−|Γ| where gamma (Γ), the reflection coefficient, is the ratio of the complex amplitude of the reflected wave to that of the incident wave. The reflection coefficient may also be referred to as the return loss. The smaller the VSWR is, the better the antenna is matched to the transmission line and the more power is delivered to the antenna(s). Conversely, the larger the VSWR is the worse the antenna is matched to the transmission loss and less power is delivered to the antenna(s).

The UE 205 may use the transmit power for real time SAR usage but may factor in the reflected transmit power and use the actual radiated power metric instead of the computed transmit power at the antenna(s) input. This approach may allow the UE 205 to satisfy the SAR threshold requirements with the least amount of transmit power backoff and, therefore, allow the UE 205 to transmit at a higher transmit power in the SAR limited scenarios. In some aspects, this approach may support a gain of 3-10 dB in some scenarios and may improve uplink coverage and performance.

In some aspects, the antenna efficiency metric may be based on a state of the UE 205. For example, the state may be based on any sensor input(s) associated with the UE 205, a grip-state of the UE 205, a folded or unfolded state of the UE 205, an orientation of the UE 205, or other states or factors that may impact the actual radiation power level from the antenna(s) of the UE 205. For example, the UE 205 may identify, determine or otherwise perform a characterization of some specific scenarios where the antenna(s) efficiency changes (e.g., various device states, folded vs unfolded, hand-grip scenarios, and others). Once these scenarios are detected, the characterized offset (e.g., the antenna efficiency metric) may be used to lower the computation of the actual SAR exposure based on the current transmit power level. For example, this may allow the UE 205 to transmit at a higher transmit power level while still maintaining the same target SAR, which may improve the uplink coverage and performance of the UE 205.

In some aspects, the UE 205 may change or otherwise update the antenna efficiency metric in response to detecting a change to the state of the UE 205. For example, the UE 205 may identify or otherwise determine a change to the state of the UE 205 and recalculate or otherwise identify an updated antenna efficiency metric. The update to the antenna efficiency metric may be used to determine an update to the second transmit power level. That is, the UE 205 may respond to any or all detected changes to the state of the UE 205 by updating or otherwise determining an updated antenna efficiency metric of the UE 205. The UE 205 may use the updated antenna efficiency metric to determine an updated second transmit power level to be applied to the transmission(s) performed by the UE 205. This may permit the UE 205 to maintain compliance with the SAR threshold in real-time while maximizing its uplink coverage and performance associated with increased transmit power levels.

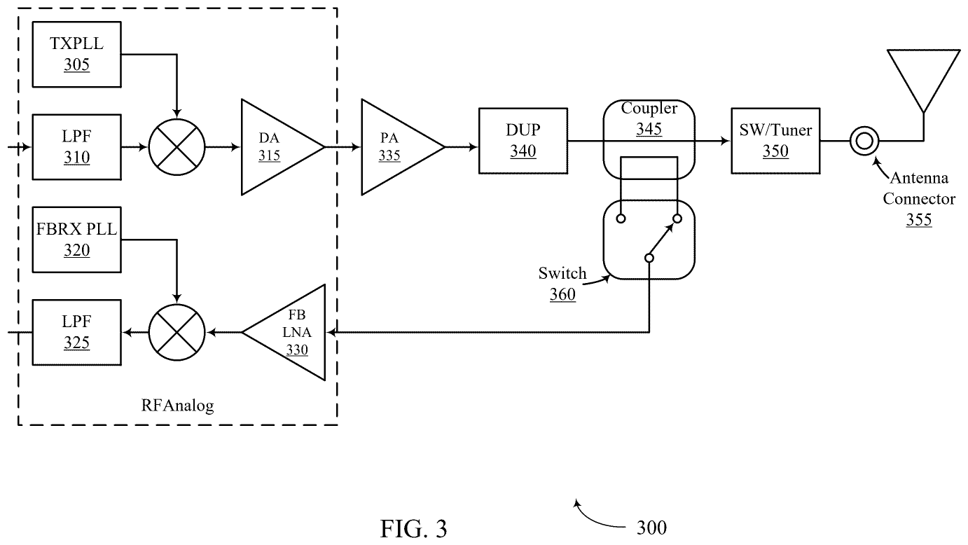

FIG. 3 shows an example of a transmit/receive chain 300 that supports smart transmit power with real time antenna efficiency in accordance with one or more aspects of the present disclosure. Transmit/receive chain 300 may implement aspects of wireless communications system 100 or wireless communications system 200. Transmit/receive chain 300 may include an RF analog component that includes a transmit phase-lock loop (TX PLL) 305 and a low-pass filter (LPF) 310 coupled to a digital amplifier (DA) 315 via a mixer/multiplier on the transmit side and a feedback receiver PLL (FBRX PLL) 320 and a LPF 325 coupled via a mixer/multiplier from a feedback low-noise amplifier (FB LNA) 330 on the receive side. Transmit/receive chain 300 may further include a PA 335, a duplexer (DUP) 340, a coupler 345, a switch (SW)/tuner 350, an antenna connector 355, and a switch 360. Aspects of transmit/receive chain 300 may be implemented at or implemented by a UE, which may be an example of the corresponding device described herein.

As discussed above, aspects of the techniques described herein provide for the UE to adjust (e.g., increase) its transmit power level based on its antenna efficiency metric in a manner that maintains compliance with the SAR threshold while maximizing uplink transmit power. For example, the UE may select a first transmit power level that is associated with a first expected radiation power from antenna(s) of the UE. The first transmit power level may be based on the first expected radiation power complying with the SAR threshold. For example, the first transmit power level may assume that the full transmit power applied from the transmission line to the antenna(s) of the UE will be radiated from the antenna(s) of the UE.

However, the UE may increase the first transmit power level to a second transmit power level that is associated with a second expected radiation power from the antenna(s) of the UE. The increase may be based on the application of the antenna efficiency metric associated with the antenna(s) to the second expected radiation power to determine a reduced expected radiation power. That is, the antenna efficiency metric may consider the impedance mismatch between the transmission line and the antenna, which may further include any impedance loss associated with the antenna connector 355. For example, the antenna efficiency metric may be based on a VSWR, a state of the UE, or both features that reduce, at least to some degree, the amount of radiated power from the antenna(s) of the UE. The UE may perform transmission(s) from the antenna(s) at the second transmit power level based on the reduced expected radiation power satisfying the SAR threshold.

Transmit/receive chain 300 illustrates a non-limiting example of one technique to identify or otherwise determine the VSWR associated with the antenna(s) of the UE as it impacts the antenna efficiency metric. For example, modulated and encoded information to be transmitted may be obtained at the RF analog portion into the LPF 310 for filtering. The output of the LPF 310 may be applied to the mixer/multiplier along with the output of the TX PLL 305 to increase the frequency of the signal for transmission. The output of the mixer/multiplier may be applied to the DA 315 for a first stage of amplification. The output of the DA 315 may be applied to the PA 335 for further amplification (e.g., to a transmit power level). The output of the PA 335 may be applied to the duplexer 340 that separates the incoming signal (e.g., from the PA 335) from an outgoing signal (e.g., any signal received from the coupler 345, such as any reflected signal). The output of the duplexer 340 may be applied to the SW/tuner 350 for application to the antenna of the UE via the antenna connector 355.

The coupler 345 may wirelessly couple the signal propagating along the transmission line as an input to the FB LNA 330 via the switch 360. For example, when the switch 360 is placed in a first position the coupler 345 may couple the incident wave being applied to the antenna to the FB LNA 330. When the switch 360 is placed in a second position the coupler 345 may couple a reflected wave that is reflected back onto the transmission line from the antenna to the FB LNA 330. Accordingly, the switch 360 may provide a means for the UE to measure or otherwise determine the VSWR associated with the antenna(s) (e.g., to identify or otherwise determine the antenna efficiency metric of the UE). For example, the output of the FB LNA 330 (e.g., after amplification) may be provided into the mixer/multiplier to be coupled with the FBRX PLL 320 output (e.g., to reduce the frequency of the applied signal). The output of the mixer/multiplier may be provided to the LPF 325 for filtering and then further processing by the receive circuitry of the UE. For example, the amplitude of the incident wave and the reflected wave may be measured to identify or otherwise determine the reflection coefficient (e.g., to identify the VSWR) associated with the antenna(s) of the UE. Accordingly, the directional coupler (e.g., the coupler 345) may be used to separate the incident and reflected waves in the transmission line for measurement or other quantification. The VSWR may also capture both the transmit reference capture and the FB RX capture to be used to estimate the gain and phase of the incident and reflected wave(s).

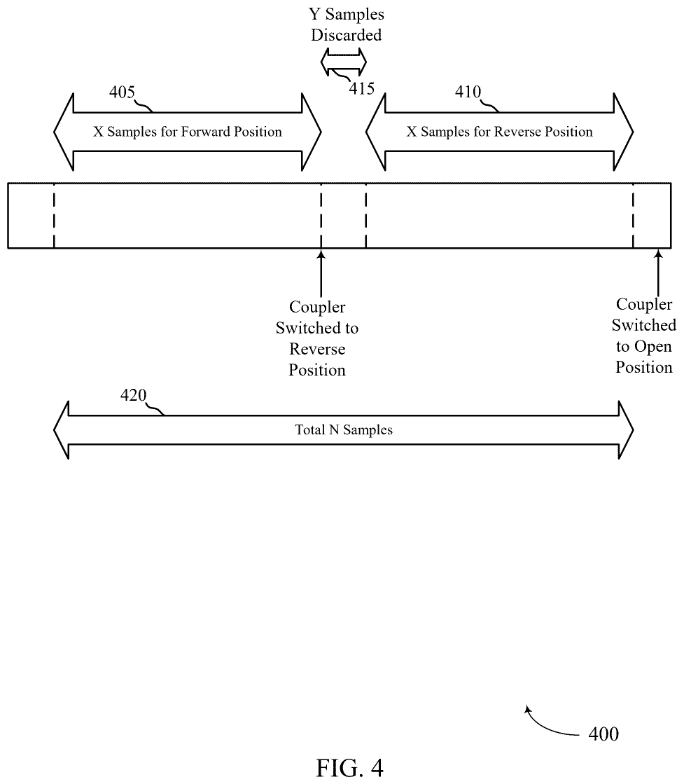

FIG. 4 shows an example of a capture scheme 400 that supports smart transmit power with real time antenna efficiency in accordance with one or more aspects of the present disclosure. Capture scheme 400 may implement aspects of wireless communications system 100 or wireless communications system 200 or aspects of transmit/receive chain 300. Aspects of capture scheme 400 may be implemented at or implemented by a UE, which may be an example of the corresponding device described herein.

As discussed above, aspects of the techniques described herein provide for the UE to adjust (e.g., increase) its transmit power level based on its antenna efficiency metric in a manner that maintains compliance with the SAR threshold. For example, the UE may select a first transmit power level that is associated with a first expected radiation power from antenna(s) of the UE. The first transmit power level may be based on the first expected radiation power being in compliance with the SAR threshold. For example, the first transmit power level may assume that the full transmit power applied to the transmission line and then onto the antenna of the UE will be radiated from the antenna(s) of the UE.

However, the UE may increase the first transmit power level to a second transmit power level that is associated with a second expected radiation power from the antenna(s) of the UE. The increase may be based on the application of the antenna efficiency metric associated with the antenna(s) to the second expected radiation power to determine a reduced expected radiation power. That is, the antenna efficiency metric may consider the impedance mismatch between the transmission line and the antenna. In some aspects, the antenna efficiency metric may be based on a VSWR, a state of the UE, or both features that reduce, at least to some degree, the amount of radiated power from the antenna(s) of the UE. The UE may perform transmission(s) from the antenna(s) at the second transmit power level based on the reduced expected radiation power satisfying the SAR threshold.

Capture scheme 400 illustrates a non-limiting example of how the VSWR may be measured or otherwise determined in accordance with the techniques described herein. Aspects of the capture scheme may be implemented using component(s) discussed above with reference to the transmit/receive chain 300. Capture scheme 400 may provide a non-limiting example where the UE captures N samples to be analyzed or otherwise measured to determine the reflection coefficient associated with the antenna(s) of the UE.

For example, the UE may use a coupler that switches the signal propagating along the transmission from a first direction (e.g., the incident wave) and a second direction (e.g., the reflected wave) for measurements. For example, the coupler may initially be switched to the first or forward position for a first sample 405. The first sample 405 may include X samples of the incident wave being captured and provided to the receive chain of the UE for measurement. The coupler may then be switched to a second or reverse position for a second sample 410. The second sample 410 may again include X samples of the reflected wave being captured and provided to the receive chain of the UE for measurement. In some cases, a third sample 415 may be used where Y samples are discarded. The third sample 415 may be discarded to avoid interference in the captured samples due to the switching of the coupler from the forward to the reverse position, or vice versa. That is, chatter or other interference may be introduced when the coupler is switched which may introduce erroneous samples. Accordingly, those Y erroneous samples may be discarded to improve measurement accuracy. Accordingly, a total samples 420 may be captured via the coupler and used to identify or otherwise determine the reflection coefficient. The reflection coefficient may be used to identify or otherwise determine the second transmit power level such that SAR compliance is maintained. The UE may perform transmission(s) at the second transmit power level according to the reduced expected radiation power satisfying the SAR threshold.

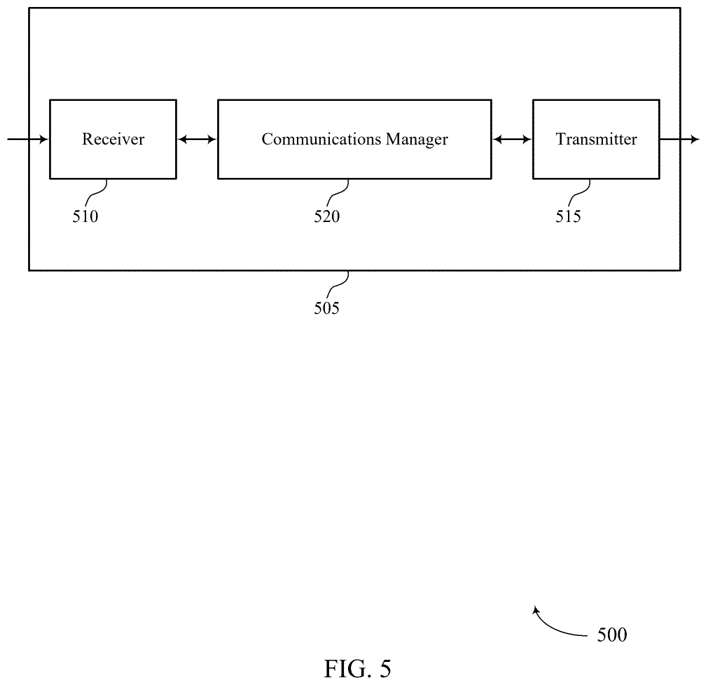

FIG. 5 shows a block diagram 500 of a device 505 that supports smart transmit power with real time antenna efficiency in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include one or more processors, memory coupled with the one or more processors, and instructions stored in the memory that are executable by the one or more processors to perform the real time antenna efficiency features discussed herein. Each of these components may be in communication with one another (e.g., via one or more buses).

The receiver 510 may provide a means for receiving information such as packets, user data, control information, or any combination thereof associated with various information channels (e.g., control channels, data channels, information channels related to smart transmit power with real time antenna efficiency). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to smart transmit power with real time antenna efficiency). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of smart transmit power with real time antenna efficiency as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for selecting, for the UE, a first transmit power level that is associated with a first expected radiation power from one or more antennas of the UE, where selection of the first transmit power level is based on the first expected radiation power being in compliance with a SAR threshold. The communications manager 520 is capable of, configured to, or operable to support a means for increasing the first transmit power level to a second transmit power level that is associated with a second expected radiation power from the one or more antennas of the UE, where the increase to the second transmit power level is based on application of an antenna efficiency metric associated with the one or more antennas of the UE to the second expected radiation power to determine a reduced expected radiation power. The communications manager 520 is capable of, configured to, or operable to support a means for performing one or more transmissions from the one or more antennas at the second transmit power level based on the reduced expected radiation power satisfying the SAR threshold.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for increasing the transmit power level applied to the antenna(s) of the UE based on application of an antenna efficiency metric associated with the antenna(s).

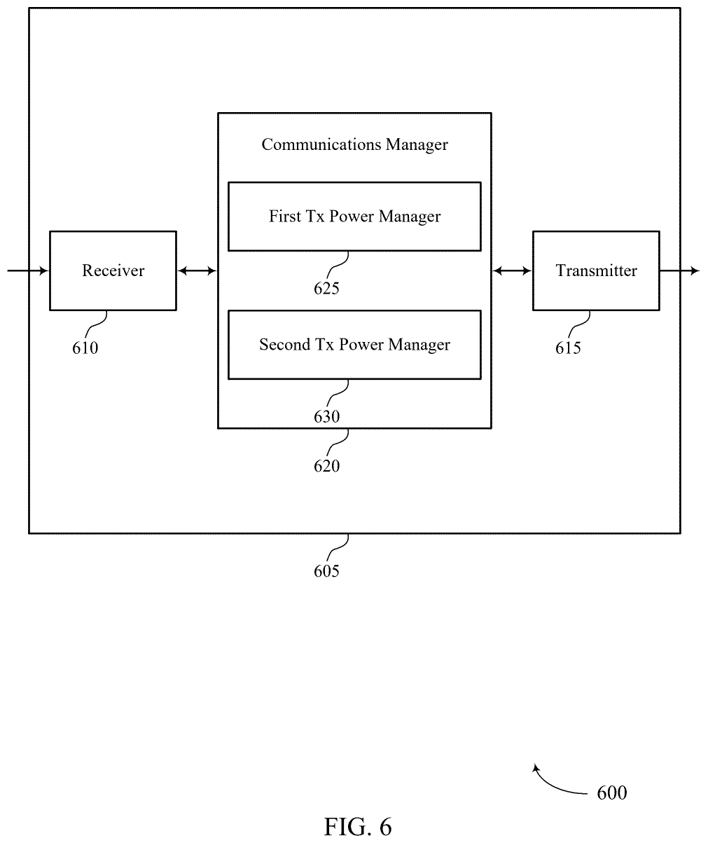

FIG. 6 shows a block diagram 600 of a device 605 that supports smart transmit power with real time antenna efficiency in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to smart transmit power with real time antenna efficiency). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to smart transmit power with real time antenna efficiency). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of smart transmit power with real time antenna efficiency as described herein. For example, the communications manager 620 may include a first Tx power manager 625 a second Tx power manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The first Tx power manager 625 is capable of, configured to, or operable to support a means for selecting, for the UE, a first transmit power level that is associated with a first expected radiation power from one or more antennas of the UE, where selection of the first transmit power level is based on the first expected radiation power being in compliance with a SAR threshold. The second Tx power manager 630 is capable of, configured to, or operable to support a means for increasing the first transmit power level to a second transmit power level that is associated with a second expected radiation power from the one or more antennas of the UE, where the increase to the second transmit power level is based on application of an antenna efficiency metric associated with the one or more antennas of the UE to the second expected radiation power to determine a reduced expected radiation power. The second Tx power manager 630 is capable of, configured to, or operable to support a means for performing one or more transmissions from the one or more antennas at the second transmit power level based on the reduced expected radiation power satisfying the SAR threshold.

In some cases, the first Tx power manager 625 and the second Tx power manager 630 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the first Tx power manager 625 and the second Tx power manager 630 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

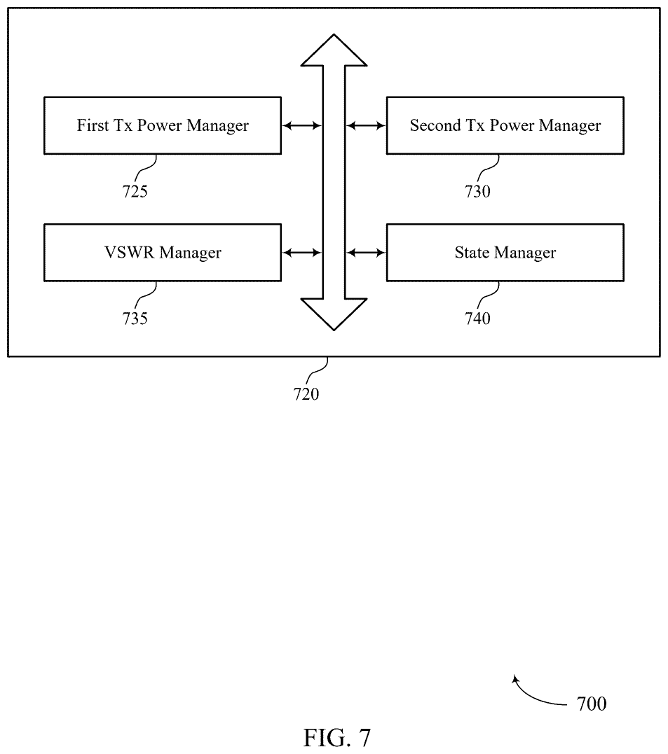

FIG. 7 shows a block diagram 700 of a communications manager 720 that supports smart transmit power with real time antenna efficiency in accordance with one or more aspects of the present disclosure. The communications manager 720 may be an example of aspects of a communications manager 520, a communications manager 620, or both, as described herein. The communications manager 720, or various components thereof, may be an example of means for performing various aspects of smart transmit power with real time antenna efficiency as described herein. For example, the communications manager 720 may include a first Tx power manager 725, a second Tx power manager 730, an VSWR manager 735, a state manager 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The first Tx power manager 725 is capable of, configured to, or operable to support a means for selecting, for the UE, a first transmit power level that is associated with a first expected radiation power from one or more antennas of the UE, where selection of the first transmit power level is based on the first expected radiation power being in compliance with a SAR threshold. The second Tx power manager 730 is capable of, configured to, or operable to support a means for increasing the first transmit power level to a second transmit power level that is associated with a second expected radiation power from the one or more antennas of the UE, where the increase to the second transmit power level is based on application of an antenna efficiency metric associated with the one or more antennas of the UE to the second expected radiation power to determine a reduced expected radiation power. In some examples, the second Tx power manager 730 is capable of, configured to, or operable to support a means for performing one or more transmissions from the one or more antennas at the second transmit power level based on the reduced expected radiation power satisfying the SAR threshold.

In some examples, the antenna efficiency metric is based on a VSWR associated with the one or more antennas. In some examples, the VSWR manager 735 is capable of, configured to, or operable to support a means for measuring the VSWR associated with the one or more antennas according to a periodic schedule. In some examples, the VSWR manager 735 is capable of, configured to, or operable to support a means for measuring the VSWR associated with the one or more antennas based on a state-change associated with the UE. In some examples, to support measuring the VSWR, the VSWR manager 735 is capable of, configured to, or operable to support a means for measuring an incident wave being provided to the one or more antennas via a transmission line and a reflected wave that is reflected onto the transmission line from the one or more antennas. In some examples, the VSWR is based on at least one of an impedance mismatch or a reflection coefficient associated with the one or more antennas.

In some examples, the antenna efficiency metric is based on a state of the UE. In some examples, the state manager 740 is capable of, configured to, or operable to support a means for determining a change to the state of the UE. In some examples, the state manager 740 is capable of, configured to, or operable to support a means for updating the antenna efficiency metric according to the change to the state of the UE, where the update to the antenna efficiency metric is associated with an update to the second transmit power level. In some examples, the state of the UE is based on at least one of one or more sensor inputs associated with the UE, or a grip-state of the UE, or a fold-state of the UE, or an orientation of the UE, or a combination thereof.

In some cases, the communications manager 720, the first Tx power manager 725, the second Tx power manager 730, the VSWR manager 735, and the state manager 740, may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the communications manager 720, the first Tx power manager 725, the second Tx power manager 730, the VSWR manager 735, and the state manager 740 discussed herein.

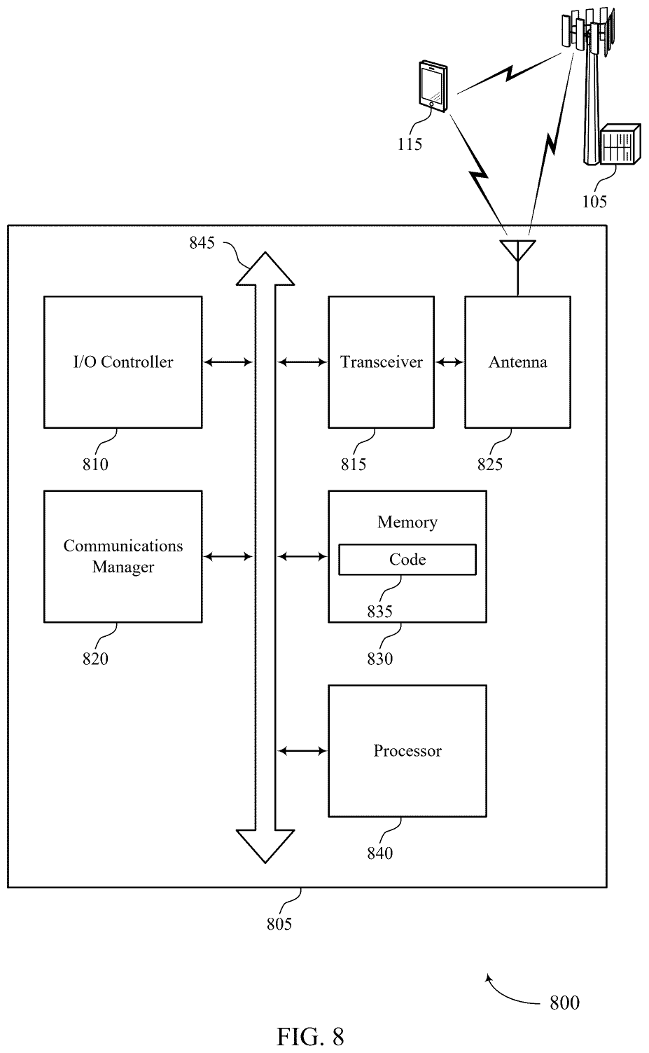

FIG. 8 shows a diagram of a system 800 including a device 805 that supports smart transmit power with real time antenna efficiency in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting smart transmit power with real time antenna efficiency). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for selecting, for the UE, a first transmit power level that is associated with a first expected radiation power from one or more antennas of the UE, where selection of the first transmit power level is based on the first expected radiation power being in compliance with a SAR threshold. The communications manager 820 is capable of, configured to, or operable to support a means for increasing the first transmit power level to a second transmit power level that is associated with a second expected radiation power from the one or more antennas of the UE, where the increase to the second transmit power level is based on application of an antenna efficiency metric associated with the one or more antennas of the UE to the second expected radiation power to determine a reduced expected radiation power. The communications manager 820 is capable of, configured to, or operable to support a means for performing one or more transmissions from the one or more antennas at the second transmit power level based on the reduced expected radiation power satisfying the SAR threshold.

By including or configuring the communications manager 820 in accordance with examples as described herein, the device 805 may support techniques for increasing the transmit power level applied to the antenna(s) of the UE based on application of an antenna efficiency metric associated with the antenna(s).

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of smart transmit power with real time antenna efficiency as described herein, or the at least one processor 840 and the at least one memory 830 may be otherwise configured to, individually or collectively, perform or support such operations.

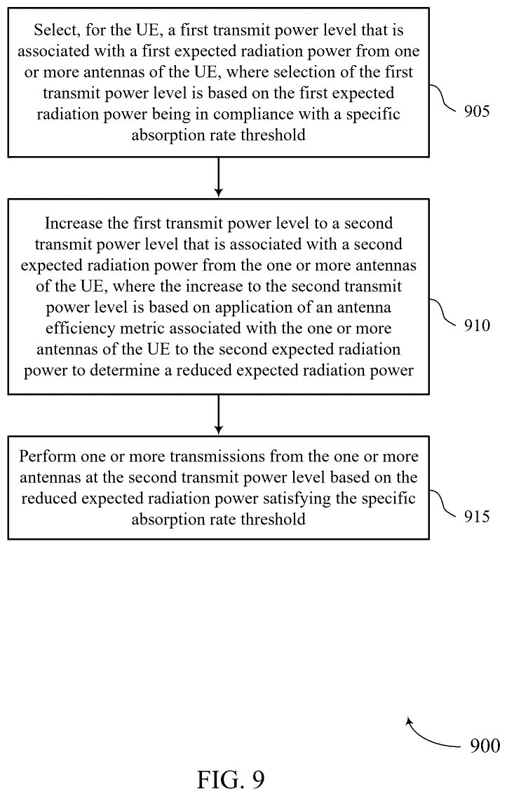

FIG. 9 shows a flowchart illustrating a method 900 that supports smart transmit power with real time antenna efficiency in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include selecting, for the UE, a first transmit power level that is associated with a first expected radiation power from one or more antennas of the UE, where selection of the first transmit power level is based on the first expected radiation power being in compliance with a SAR threshold. The operations of 905 may be performed in accordance with examples as disclosed herein. In some examples, aspects of the operations of 905 may be performed by a first Tx power manager 725 as described with reference to FIG. 7.

At 910, the method may include increasing the first transmit power level to a second transmit power level that is associated with a second expected radiation power from the one or more antennas of the UE, where the increase to the second transmit power level is based on application of an antenna efficiency metric associated with the one or more antennas of the UE to the second expected radiation power to determine a reduced expected radiation power. The operations of 910 may be performed in accordance with examples as disclosed herein. In some examples, aspects of the operations of 910 may be performed by a second Tx power manager 730 as described with reference to FIG. 7.

At 915, the method may include performing one or more transmissions from the one or more antennas at the second transmit power level based on the reduced expected radiation power satisfying the SAR threshold. The operations of 915 may be performed in accordance with examples as disclosed herein. In some examples, aspects of the operations of 915 may be performed by a second Tx power manager 730 as described with reference to FIG. 7.

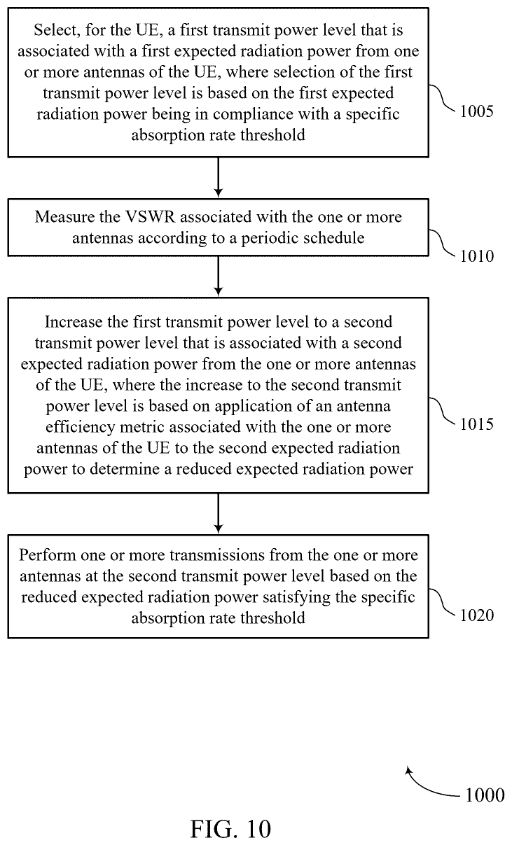

FIG. 10 shows a flowchart illustrating a method 1000 that supports smart transmit power with real time antenna efficiency in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include selecting, for the UE, a first transmit power level that is associated with a first expected radiation power from one or more antennas of the UE, where selection of the first transmit power level is based on the first expected radiation power being in compliance with a SAR threshold. The operations of 1005 may be performed in accordance with examples as disclosed herein. In some examples, aspects of the operations of 1005 may be performed by a first Tx power manager 725 as described with reference to FIG. 7.

At 1010, the method may include measuring the VSWR associated with the one or more antennas according to a periodic schedule. The operations of 1010 may be performed in accordance with examples as disclosed herein. In some examples, aspects of the operations of 1010 may be performed by an VSWR manager 735 as described with reference to FIG. 7.

At 1015, the method may include increasing the first transmit power level to a second transmit power level that is associated with a second expected radiation power from the one or more antennas of the UE, where the increase to the second transmit power level is based on application of an antenna efficiency metric associated with the one or more antennas of the UE to the second expected radiation power to determine a reduced expected radiation power. The operations of 1015 may be performed in accordance with examples as disclosed herein. In some examples, aspects of the operations of 1015 may be performed by a second Tx power manager 730 as described with reference to FIG. 7.

At 1020, the method may include performing one or more transmissions from the one or more antennas at the second transmit power level based on the reduced expected radiation power satisfying the SAR threshold. The operations of 1020 may be performed in accordance with examples as disclosed herein. In some examples, aspects of the operations of 1020 may be performed by a second Tx power manager 730 as described with reference to FIG. 7.

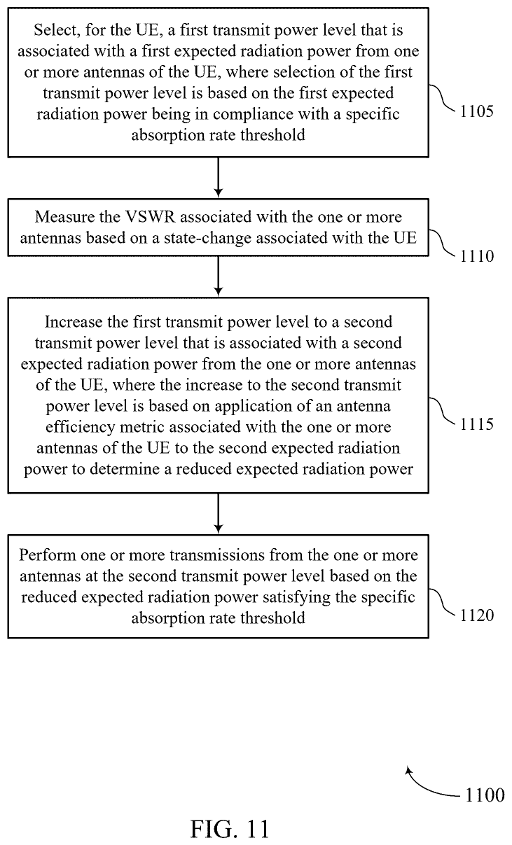

FIG. 11 shows a flowchart illustrating a method 1100 that supports smart transmit power with real time antenna efficiency in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include selecting, for the UE, a first transmit power level that is associated with a first expected radiation power from one or more antennas of the UE, where selection of the first transmit power level is based on the first expected radiation power being in compliance with a SAR threshold. The operations of 1105 may be performed in accordance with examples as disclosed herein. In some examples, aspects of the operations of 1105 may be performed by a first Tx power manager 725 as described with reference to FIG. 7.

At 1110, the method may include measuring the VSWR associated with the one or more antennas based on a state-change associated with the UE. The operations of 1110 may be performed in accordance with examples as disclosed herein. In some examples, aspects of the operations of 1110 may be performed by an VSWR manager 735 as described with reference to FIG. 7.

At 1115, the method may include increasing the first transmit power level to a second transmit power level that is associated with a second expected radiation power from the one or more antennas of the UE, where the increase to the second transmit power level is based on application of an antenna efficiency metric associated with the one or more antennas of the UE to the second expected radiation power to determine a reduced expected radiation power. The operations of 1115 may be performed in accordance with examples as disclosed herein. In some examples, aspects of the operations of 1115 may be performed by a second Tx power manager 730 as described with reference to FIG. 7.

At 1120, the method may include performing one or more transmissions from the one or more antennas at the second transmit power level based on the reduced expected radiation power satisfying the SAR threshold. The operations of 1120 may be performed in accordance with examples as disclosed herein. In some examples, aspects of the operations of 1120 may be performed by a second Tx power manager 730 as described with reference to FIG. 7.

The following provides an overview of aspects of the present disclosure:

Aspect 1: A method for wireless communications at a UE, comprising: selecting, for the UE, a first transmit power level that is associated with a first expected radiation power from one or more antennas of the UE, wherein selection of the first transmit power level is based at least in part on the first expected radiation power being in compliance with a specific absorption rate threshold; increasing the first transmit power level to a second transmit power level that is associated with a second expected radiation power from the one or more antennas of the UE, wherein the increase to the second transmit power level is based at least in part on application of an antenna efficiency metric associated with the one or more antennas of the UE to the second expected radiation power to determine a reduced expected radiation power; and performing one or more transmissions from the one or more antennas at the second transmit power level based at least in part on the reduced expected radiation power satisfying the specific absorption rate threshold.

Aspect 2: The method of aspect 1, wherein the antenna efficiency metric is based at least in part on a VSWR associated with the one or more antennas.

Aspect 3: The method of aspect 2, further comprising: measuring the VSWR associated with the one or more antennas according to a periodic schedule.

Aspect 4: The method of any of aspects 2 through 3, further comprising: measuring the VSWR associated with the one or more antennas based at least in part on a state-change associated with the UE.

Aspect 5: The method of any of aspects 2 through 4, wherein measuring the VSWR comprises: measuring an incident wave being provided to the one or more antennas via a transmission line and a reflected wave that is reflected onto the transmission line from the one or more antennas.

Aspect 6: The method of any of aspects 2 through 5, wherein the VSWR is based on at least one of an impedance mismatch or a reflection coefficient associated with the one or more antennas.

Aspect 7: The method of any of aspects 1 through 6, wherein the antenna efficiency metric is based at least in part on a state of the UE.

Aspect 8: The method of aspect 7, further comprising: determining a change to the state of the UE; and updating the antenna efficiency metric according to the change to the state of the UE, wherein the update to the antenna efficiency metric is associated with an update to the second transmit power level.

Aspect 9: The method of any of aspects 7 through 8, wherein the state of the UE is based on at least one of one or more sensor inputs associated with the UE, or a grip-state of the UE, or a fold-state of the UE, or an orientation of the UE, or a combination thereof.

Aspect 10: A UE for wireless communications, comprising one or more memories storing processor-executable code and one or more processors coupled with the one or more memories, wherein the one or more processors are individually or collectively configured to cause the UE to perform a method of any of aspects 1 through 9.

Aspect 11: A UE for wireless communications, comprising at least one means for performing a method of any of aspects 1 through 9.

Aspect 12: A non-transitory computer-readable medium storing code for wireless communications, the code comprising instructions executable by one or more processors to perform a method of any of aspects 1 through 9.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories, wherein the one or more processors are individually or collectively configured to cause the UE to:
select, for the UE, a first transmit power level that is associated with a first expected radiation power from one or more antennas of the UE, wherein selection of the first transmit power level is based at least in part on the first expected radiation power being in compliance with a specific absorption rate threshold;
increase the first transmit power level to a second transmit power level that is associated with a second expected radiation power from the one or more antennas of the UE, wherein the increase to the second transmit power level is based at least in part on application of an antenna efficiency metric associated with the one or more antennas of the UE to the second expected radiation power to determine a reduced expected radiation power; and
perform one or more transmissions from the one or more antennas at the second transmit power level based at least in part on the reduced expected radiation power satisfying the specific absorption rate threshold.

2. The UE of claim 1, wherein the antenna efficiency metric is based at least in part on a voltage standing wave ratio (VSWR) associated with the one or more antennas.

3. The UE of claim 2, wherein the one or more processors are individually or collectively further configured to cause the UE to:
measure the VSWR associated with the one or more antennas according to a periodic schedule.

4. The UE of claim 2, wherein the one or more processors are individually or collectively further configured to cause the UE to:
measure the VSWR associated with the one or more antennas based at least in part on a state-change associated with the UE.

5. The UE of claim 2, wherein, to measure the VSWR, the one or more processors are individually or collectively further configured to cause the UE to:
measure an incident wave being provided to the one or more antennas via a transmission line and a reflected wave that is reflected onto the transmission line from the one or more antennas.

6. The UE of claim 2, wherein the VSWR is based on at least one of an impedance mismatch or a reflection coefficient associated with the one or more antennas.

7. The UE of claim 1, wherein the antenna efficiency metric is based at least in part on a state of the UE.

8. The UE of claim 7, wherein the one or more processors are individually or collectively further configured to cause the UE to:
determine a change to the state of the UE; and
update the antenna efficiency metric according to the change to the state of the UE, wherein the update to the antenna efficiency metric is associated with an update to the second transmit power level.

9. The UE of claim 7, wherein the state of the UE is based on at least one of one or more sensor inputs associated with the UE, or a grip-state of the UE, or a fold-state of the UE, or an orientation of the UE, or a combination thereof.

10. A method for wireless communications at a user equipment (UE), comprising:
selecting, for the UE, a first transmit power level that is associated with a first expected radiation power from one or more antennas of the UE, wherein selection of the first transmit power level is based at least in part on the first expected radiation power being in compliance with a specific absorption rate threshold;
increasing the first transmit power level to a second transmit power level that is associated with a second expected radiation power from the one or more antennas of the UE, wherein the increase to the second transmit power level is based at least in part on application of an antenna efficiency metric associated with the one or more antennas of the UE to the second expected radiation power to determine a reduced expected radiation power; and
performing one or more transmissions from the one or more antennas at the second transmit power level based at least in part on the reduced expected radiation power satisfying the specific absorption rate threshold.

11. The method of claim 10, wherein the antenna efficiency metric is based at least in part on a voltage standing wave ratio (VSWR) associated with the one or more antennas.

12. The method of claim 11, further comprising:
measuring the VSWR associated with the one or more antennas according to a periodic schedule.

13. The method of claim 11, further comprising:
measuring the VSWR associated with the one or more antennas based at least in part on a state-change associated with the UE.

14. The method of claim 11, wherein measuring the VSWR comprises:
measuring an incident wave being provided to the one or more antennas via a transmission line and a reflected wave that is reflected onto the transmission line from the one or more antennas.

15. The method of claim 11, wherein the VSWR is based on at least one of an impedance mismatch or a reflection coefficient associated with the one or more antennas.

16. The method of claim 10, wherein the antenna efficiency metric is based at least in part on a state of the UE.

17. The method of claim 16, further comprising:
determining a change to the state of the UE; and
updating the antenna efficiency metric according to the change to the state of the UE, wherein the update to the antenna efficiency metric is associated with an update to the second transmit power level.

18. The method of claim 16, wherein the state of the UE is based on at least one of one or more sensor inputs associated with the UE, or a grip-state of the UE, or a fold-state of the UE, or an orientation of the UE, or a combination thereof.

19. A non-transitory computer-readable medium storing code for wireless communications, the code comprising instructions executable by one or more processors to:
select, for a user equipment (UE), a first transmit power level that is associated with a first expected radiation power from one or more antennas of the UE, wherein selection of the first transmit power level is based at least in part on the first expected radiation power being in compliance with a specific absorption rate threshold;
increase the first transmit power level to a second transmit power level that is associated with a second expected radiation power from the one or more antennas of the UE, wherein the increase to the second transmit power level is based at least in part on application of an antenna efficiency metric associated with the one or more antennas of the UE to the second expected radiation power to determine a reduced expected radiation power; and
perform one or more transmissions from the one or more antennas at the second transmit power level based at least in part on the reduced expected radiation power satisfying the specific absorption rate threshold.

20. The non-transitory computer-readable medium of claim 19, wherein the antenna efficiency metric is based at least in part on a voltage standing wave ratio (VSWR) associated with the one or more antennas.
